(19) United States
(12) Patent Application Publication
(10) Pub. No.: US 2026/0330202 A1
(43) Pub. Date: Oct. 22, 2026

(54) SYSTEM AND METHOD FOR MITIGATING HALLUCINATIONS IN TRANSFORMER MODELS

(71) Applicant: AIOLA LTD., Herzliya (IL)

(72) Inventors: Aviv SHAMSIAN, Holon (IL); Aviv NAVON, Alonei Abba (IL); Gill HETZ, Beit Lehem HaGlilit (IL); Joseph KESHET, Tel-Aviv (IL); Yael SEGAL, Ofra (IL)

(73) Assignee: AIOLA LTD., Herzliya (IL)

(21) Appl. No.: 19/560,434

(22) Filed: Mar. 9, 2026

Related U.S. Application Data
(60) Provisional application No. 63/769,284, filed on Mar. 10, 2025.

(51) Int. Cl. G06N 3/0499; G06N 3/0455; G06V 10/764; G10L 15/16

(52) U.S. Cl. CPC G06N 3/0499; G06N 3/0455; G06V 10/764; G10L 15/16

(57) ABSTRACT

A system and method of mitigating hallucinations may include receiving an input data signal, comprising a sequence of input data segments, and processing the input data segments through an encoder of a transformer-based model, to generate a respective sequence of encoding vectors. The encoding vectors may be processed through a decoder of the transformer-based model, to generate a set of candidate sequences, each representing a first transformation of the input data signal. A deep Neural Network may be applied on the encoding vectors, to obtain a reference sequence, representing a second transformation of the input data signal. Each of the candidate sequences may be aligned with the reference sequence. For each candidate sequence of the set of candidate sequences, a respective probability score may be computed to indicate a quality of its respective alignment. A candidate sequence may be identified as an hallucination, based on its respective probability score.

### CROSS-REFERENCE TO RELATED APPLICATIONS

This application claims the benefit of priority of U.S. patent application Ser. No. 63/769,284, filed 10 Mar. 2025, which is hereby incorporated by reference.

### FIELD OF INVENTION

The present invention relates generally to the field of transformer-based machine-learning models. More specifically, the present invention relates to mitigating hallucinations in transformer-based models.

### BACKGROUND

Transformer-based models are commonly used for transferring data sequences or structures from a first representation, in a first domain, to a second representation, in a second domain. Such transformers are typically composed of two elements: an encoder, which learns an effective representation of an input data sequence, and a decoder that generates a corresponding output data sequence, given the encoder representation.

For example, a transformer-based, speech transcription model may receive a sequence of data elements representing recorded speech, in an audio data domain. The transcription model may transcribe the recorded speech by producing a sequence of token data elements (e.g., words, characters, etc.) in a textual data domain.

More specifically, an encoder of a transformer-based, speech transcription model may receive the input audio sequence of speech, and produce therefrom a sequence of encoding vectors, each representing segments of the recorded speech. A decoder of the transformer-based model may transcribe the input speech by iteratively predicting the sequence of textual output tokens given the encoder representation.

As known in the art, using transformer-based, encoder-decoder architectures may provide several benefits over encoder-only architectures, but may also have some drawbacks. In the example of speech transcription, unlike encoder-only architectures, transformer-based, encoder-decoder architectures may overcome difficulties in transcribing short audio data elements (especially in languages that use long words) or when dealing with very fast speech. However, since token prediction in encoder-decoder architectures is not directly constrained by the length or content of the input data sequence (e.g., the recorded audio), encoder-decoder models may be prone to producing a specific type of errors, commonly referred to as hallucinations.

As known in the art, the term “hallucination” may refer to a type of errors in which the transformed information is completely absent from the original input.

Pertaining to the example of transcription models having encoder-decoder architectures, hallucinations will not be limited to mere errors, where a limited number of characters are replaced (e.g., transcribing the word “bat” to “mat”), e.g., due to biases in the transformer's training data or misinterpretation of ambiguous audio segments.

Instead, a hallucination may include, for example, one or more repetitions, where the model may generate repetitive text that is not present in the original audio. For example, when an input speech sample contains the sentence “The cat sat on the mat”, a repetitive hallucination may produce a transcription such as “The cat sat cat sat cat sat on the mat”.

In another example, a hallucination of an encoder-decoder transcription model may include token (word) insertion. In other words, the model may insert words or phrases that were completely absent (e.g., not spoken) in the original audio. For example, transcribing “I went to the store” may result in a hallucinated transcription of “I went to the grocery store”, when “grocery” was not actually uttered.

In another example, a hallucination of an encoder-decoder transcription model may include fabrication. In other words, the model may generate completely unrelated content, especially when dealing with low-quality audio or unfamiliar accents. For instance, transcribing “The weather is nice today” may result in a hallucinatory transcription “The political situation is tense” when there was no mention of politics in the original speech.

In each of these cases, the encoder-decoder model may generate content that is not merely inaccurate, but is absent from the original input altogether.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present invention may include a system and method for mitigating hallucinations in transformer-based machine learning models, particularly in encoder-decoder architectures used for tasks such as speech recognition. By introducing a novel alignment mechanism, embodiments of the invention may compare an output of the decoder with a reference sequence generated by a separate deep neural network processing the encoder's output. This alignment process may allow detection, and optionally amendment of hallucinatory conditions in the model's output.

Embodiments of the present invention may subsequently calculate probability scores for candidate sequences based on their alignment with the reference sequence, enabling the identification of hallucinated content not present in the original input signal. The inventors have experimentally demonstrated that this approach may significantly reduce occurrence of common hallucination types such as repetitions, insertions, and fabrications, thereby improving the accuracy and reliability of transformer-based models in various applications, including, but not limited to speech transcription and image captioning.

According to an aspect of the present disclosure, a method of mitigating hallucinations in a transformer-based model, by at least one processor is provided. Embodiments of the method may include receiving an input data signal, comprising a sequence of input data segments, and processing the input data segments through an encoder of the transformer-based model, to generate a respective sequence of encoding vectors.

According to some embodiments, the at least one processor may process the encoding vectors through a decoder of the transformer-based model, to generate a set of candidate sequences, each representing a first transformation of the input data signal. The at least one processor may apply a Deep Neural Network (DNN) on the encoding vectors, to obtain a reference sequence, representing a second transformation of the input data signal.

The at least one processor may align one or more (e.g., each) candidate sequence of the set of candidate sequences with the reference sequence, and compute, for each candidate sequence, a respective probability score, based on the alignment. The at least one processor may subsequently identify a specific candidate sequence as an hallucination, based on its respective probability score (e.g., when the probability score is below a predetermined threshold).

According to some embodiments, the at least one processor may generate the candidate sequences by an iterative process. This iterative process may include obtaining a current set of candidate sequences, pertaining to a current iteration; selecting a specific candidate sequence of the current set of candidate sequences as optimal, based on the probability scores; and in a subsequent iteration, generating a new set of candidate sequences, based on the optimal candidate sequence. Embodiment of the invention may thereby evolve the set of candidate sequences dynamically, when each candidate may be selected to spawn one or more other candidates.

According to some embodiments, the input data signal may be an audio signal, which may include, for example, recorded speech. In such embodiments, the first transformation may represent a transcription of the recorded speech into a sequence of tokens, such as natural-language words and sub-word units, thereby forming the candidate sequence. The second transformation may represent a second transcription of the recorded speech, e.g., transcription into a sequence of natural-language alphabetical characters, thereby forming the reference sequence.

The at least one processor may employ the DNN to predict, for each input data segment, a set of probabilities. This set of probabilities may represent likelihood of utterance of phonemes, which correspond to respective alphabetical characters. The at least one processor may further apply a beam search algorithm on the set of probabilities, to select specific characters based on their likelihood of utterance, and generate the reference sequence based on the selected alphabetical characters.

According to some embodiments, the at least one processor may receive (e.g., during a training stage) a sequence of training input data segments. The input data segments may be annotated according to their corresponding transcription. The at least one processor may apply the encoder on the training input data segments, to generate a respective sequence of training encoding vectors. The at least one processor may apply the DNN on one or more training encoding vectors, to obtain one or more respective, interim probability sets, and calculate a Connectionist Temporal Classification (CTC) loss value, based on the interim probability sets. The at least one processor may subsequently train the DNN to predict said reference sequence, based on the CTC loss value.

According to some embodiments, the aligning process may include employing a dynamic programming algorithm, to align at least one candidate sequence of the set of candidate sequences with the reference sequence.

Additionally, or alternatively, the input data signal may include an image. In such embodiments, the first transformation may represent the image in another information domain. For example, the first transformation may include an image captioning, such as textual description of content of one or more elements depicted in the image. In such embodiments, the DNN may include one or more object detection models, adapted to identify one or more respective predetermined objects in the image, and the second transformation may include textual indication of presence of the predetermined objects in the image.

According to another aspect, embodiments of the present invention may include a system for mitigating hallucinations in a transformer-based model. Embodiments of the system may include a non-transitory memory device, where modules of instruction code are stored, and at least one processor associated with the memory device, and configured to execute the modules of instruction code.

Upon execution of the modules of instruction code, the at least one processor may be configured to receive an input data signal, which includes a sequence of input data segments. The at least one processor may process the input data segments through an encoder of the transformer-based model, to generate a respective sequence of encoding vectors, and process the encoding vectors through a decoder of the transformer-based model, to generate a set of candidate sequences. Each candidate sequence may represent a first transformation of the input data signal, and apply a DNN on the encoding vectors, to obtain a reference sequence, representing a second transformation of the input data signal. The at least one processor may align each of the set of candidate sequences with the reference sequence. For each candidate sequence of the set of candidate sequences, the at least one processor may compute a respective probability score, based on said alignment, and identify a specific candidate sequence as an hallucination, based on its respective probability score.

Aspects of the invention may also include a system for early detection of hallucinations in a transformer-based model. Embodiments of the system may include a non-transitory memory device, wherein modules of instruction code are stored, and at least one processor associated with the memory device, and configured to execute the modules of instruction code. Upon execution of the modules of instruction code, the at least one processor may be configured to receive an input data signal, comprising a sequence of input data segments, and process the input data segments through an encoder of the transformer-based model, to generate a respective sequence of encoding vectors. The at least one processor may apply a deep Neural Network (NN) on the encoding vectors, to obtain a reference sequence representing a transformation of the input data signal. The at least one processor may iteratively generate, through a decoder of the transformer-based model, a set of candidate sequences based on the encoding vectors, wherein each iteration incorporates previously generated tokens into the candidate sequences. During said iterative generation, the at least one processor may align each candidate sequence with the reference sequence to determine an alignment score. The at least one processor may identify an onset location of a hallucinated segment within a candidate sequence by pinpointing where the candidate sequence begins to diverge from the reference sequence based on the alignment score, prior to completion of the iterative generation.

The foregoing general description of the illustrative embodiments and the following detailed description thereof are merely exemplary aspects of the teachings of this disclosure and are not restrictive.

### BRIEF DESCRIPTION OF FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for detecting hallucinations in transformer-based models, according to some embodiments;

FIG. 2 illustrates a system for processing input signals and detecting hallucinations in transformer-based models, according to aspects of the present disclosure; and

FIG. 3 is a flow diagram, depicting steps in a method of detecting hallucinations in transformer-based models by at least one processor, according to some embodiments.

### DETAILED DESCRIPTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

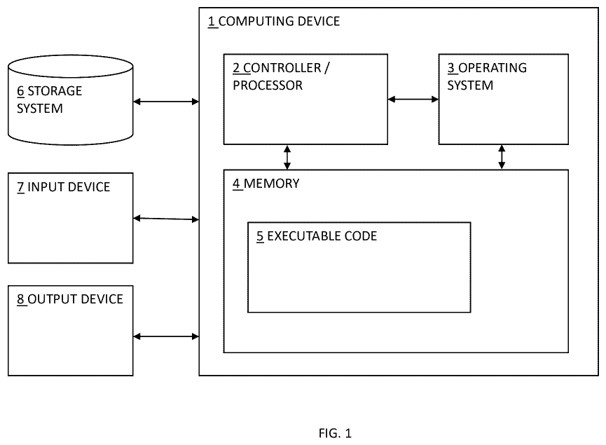

Reference is now made to FIG. 1, which is a block diagram depicting a computing device, which may be included within an embodiment of a system for detecting hallucinations in transformer-based models, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may detecting hallucinations in transformer-based models as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to transformation of input data streams may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons, and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

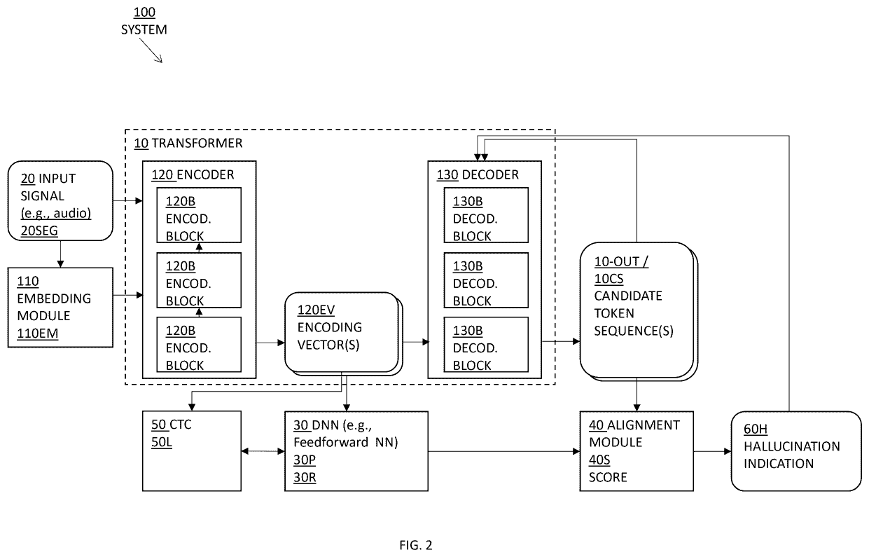

Reference is now made to FIG. 2, which depicts a system 100 for detecting hallucinations in transformer-based ML models, according to some embodiments.

According to some embodiments of the invention, system 100 may be implemented as a software module, a hardware module, or any combination thereof. For example, system may be or may include a computing device such as element 1 of FIG. 1, and may be adapted to execute one or more modules of executable code (e.g., element 5 of FIG. 1) to detect hallucinations in transformer-based machine-learning (ML) models, as further described herein.

As shown in FIG. 2, arrows may represent flow of one or more data elements to and from system 100 and/or among modules or elements of system 100. Some arrows have been omitted from FIG. 2 for the purpose of clarity.

According to some embodiments, system 100 may include, or may be associated with a transformer 10 that may be adapted to processes and transform an input signal 20 to generate an output stream of predetermined format.

For example, input signal 20 may be, or may include an audio signal 20, such as a recording of human speech, and transformer 10 may be a speech recognition model, adapted to transform input signal 20 into an output stream 10-OUT of transcribed text.

In another example, input signal 20 may be, or may include an image signal 20, such as a digital photograph or video frame, and transformer 10 may be an image captioning model, adapted to transform input signal 20 into an output stream 10-OUT of descriptive text. In this case, system 100 may analyze the visual content of the image, identifying objects, scenes, actions, and relationships, and generate output stream 10-OUT as a natural language description that captures the salient features of the image. In this case, output stream 10-OUT may include one or more sentences that provide a contextually relevant caption for the input image in signal 20.

According to some embodiments, system 100 may forward signal 20 to an embedding module 110, which may process signal 20 to generate at least one embedding vector 110EM. In the example of an audio signal 20, embedding module 110 may utilize machine learning techniques to transform raw audio data 20 into a high-dimensional, embedding vector 110EM representation.

Embedding vector representation 110EM may capture the features of the audio signal 20 in a manner that promotes the underlying task. Pertaining to the example of speech transcription, embedding vector 110EM may encode spectral and temporal characteristics of the audio input signal 20, such as frequency content, pitch variations, and formant transitions, which are significant for distinguishing between different phonemes and words. Embedding 110EM may also capture prosodic features like intonation and stress patterns, which can aid in accurately identifying word boundaries and sentence structure in the transcription process. Embedding module 110 may propagate embedding vectors 110EM to an encoder 120 of transformer 10 for further processing.

Encoder 120 may receive the embedding vector(s) 110EM from embedding module 110, and apply a series of encoding blocks 120B to the embeddings 110EM. Each encoding block 120B may process the input embedding vectors 110EM through a series of transformations, typically involving linear layers, normalization, and activation functions, as known in the art. Encoder 120 may convert embedding vectors (e.g., audio embeddings) 110EM into a set of encoding vectors 120EV, that may represent the audio data in a more abstract, and compact form.

Encoding vectors 120EV may then be passed to a decoder (e.g., an attention-based decoder) module 130. Decoder 130 may receive encoding vectors 120EV from encoder 120 and process this input through a series of decoding blocks 130B. Decoder 130 may thus generate an output vector 10-OUT representing input signal 20 (e.g., recorded audio data 20) in a transformed domain space. Pertaining to the example of speech transcription, the transformed domain space may represent a space of textual tokens.

During an inference stage, decoder 130 may evaluate multiple potential word (token) candidate sequences 10CS, and select the word sequence 10-OUT with the highest probability as its prediction. Embodiments of the invention may aim to identify and optionally amend hallucinations in tokens of output vector 10-OUT. Therefore, output vector 10-OUT may also be referred to herein as a sequence of candidate tokens 10CS, whose content may be verified or confirmed by embodiments of the invention.

System 100 may further include a Deep Neural Network (DNN) model 30 and an alignment module 40. As elaborated herein, DNN 30 may be configured to process encoding vectors 120EV generated by encoder 120. Alignment module 40 may receive outputs from both DNN 30 and the decoder 130 of transformer 10, and may generate an alignment score 40S for each candidate sequence 10CS, by comparing and aligning candidate sequences 10CS with processed encoding vectors 120EV.

System 100 may subsequently generate an hallucination indicator 60H, based on alignment score (e.g., when the alignment score falls below a predetermine threshold). Hallucination indicator 60H may indicate whether candidate sequences 10CS contain hallucinated content, such as content that misrepresents, or is not present in the original input signal 20.

As explained herein, system 100 may receive an input data signal 20 that may include a sequence of input data segments 20SEG.

In the example of an audio signal 20, input data segments 20SEG may include a time-wise sequence of short (e.g., 20 ms) audio segments 20SEG, that comprise audio signal 20. In the example of an image input signal 20, input data segments 20SEG may include patches, or tiles of small sub-images that comprise image 20.

Embedding module 110 may process input signal 20 to generate embedding vector 110EM.

For audio input signals, embedding module 110 may apply a series of convolutional and pooling operations to extract relevant acoustic features from the input data segments 20SEG. These features may then be mapped to a high-dimensional space using a learned transformation matrix, resulting in embedding vector 110EM.

For image input signals 20, embedding module 110 may employ convolutional neural networks to extract visual features from image segments 20SEG. These features may be processed to generate embedding vectors 110EM, representing high-level visual concepts and spatial relationships within the image.

The embedding process performed by embedding module 110 may serve as a preliminary step in transforming input signal 20 into a format that can be effectively processed by subsequent components of system 100, such as encoder 120, decoder 130, and DNN 30.

Additionally, or alternatively, embedding module 110 may serve as a standardized representation of input signal 20, regardless of whether it is an audio signal or an image, enabling unified processing in later stages of the transformer 10.

As explained herein, embodiments of the invention may include processing the input data segments 20SEG through an encoder 120 of the transformer-based model 10, to generate a respective sequence of encoding vectors 120EV.

The purpose of this encoding process may be to convert the input signal 20, whether in its raw form 20 or in its embedding form 110EM, into a compact, information-rich representation that captures essential characteristics of the signal, facilitating subsequent processing steps in system 100. Encoding vectors 110EM may encode spectral and temporal characteristics of the audio segments 20SEG, such as frequency content, pitch variations, and formant transitions, which may be significant for distinguishing between different phonemes and words.

Pertaining to the audio example, input signal 20 may include a 30 second recording of speech. Encoder 120 may receive this input in raw form, e.g., as 1500 segments 20SEG, each representing 20 ms of recorded audio, or in an embedding form, e.g., as 1500 embedding vectors 110EM, each representing an embedding of a 20 ms audio segment 20SEG. Encoder 120 may process audio segment 20SEG and/or embedding vectors 110EM to generate encoding vectors 120EV.

Encoding vectors 120EV may serve as input to both decoder 130 and DNN 30. Decoder 130 may use encoding vectors 120EV to predict the next token based on the encoder's output 120EV and/or previously generated tokens.

This process may enable transformer 10 to generate a first representation of the input speech signal, as one or more sequences of candidate tokens 10CS.

For example, when input signal 20 includes an audio signal of recorded speech, the first transformation represented by the candidate sequences 10CS may include a transcription of the recorded speech into a sequence of tokens. These tokens may be selected from natural-language words and sub-word units.

In another example, when the input signal 20 comprises an image, the first transformation represented by the candidate sequences 10CS may be image captioning. The candidate sequences 10CS may include tokens that are textual descriptions of content or elements depicted in the image.

According to some embodiments, decoder 130 may include multiple decoder blocks 130B arranged in sequence. Each decoder block 130B may apply a series of transformations to its input, including for example, self-attention mechanisms, cross-attention mechanisms, and feed-forward neural networks.

Decoder 130 may generate candidate sequences 10CS through an iterative process. In this process, decoder 130 may evaluate multiple potential token sequences and select the sequence with the highest probability as its prediction.

Decoder 130 may generate an initial set of candidate sequences 10CS based on the encoding vectors 120EV. System 100 may then evaluate these candidate sequences 10CS and select an optimal candidate sequence based on probability scores. In subsequent iterations, Decoder 130 may generate new sets of candidate sequences 10CS based on the previously selected optimal candidate sequence.

DNN model 30 may be, or may include a feed-forward Neural Network (NN), adapted to process the encoding vectors 120EV in parallel with decoder 130. As used herein, the terms “deep neural network,” “deep NN,” “DNN,” and “feed-forward neural network” may be used interchangeably to refer to the same component. DNN model 30 (e.g., the feed-forward NN) may be configured to generate a reference sequence 30R, which may represent a second transformation of the input signal 20, in the transformed domain.

For example, when input signal 20 includes an audio signal of recorded speech, the second transformation (represented by reference sequence 30R) may be a transcription of the recorded speech into a sequence of natural-language alphabetical characters.

According to some embodiments, DNN model 30 may (e.g., during an inference stage) be configured to predict, for each input data segment 20SEG (e.g., for each representative encoding vector 120EV), a set of probabilities 30P. This set of probabilities may represent the likelihood of utterance of alphabetical characters (e.g., ‘a’, ‘b’, ‘c’, etc.) as phonemes in audio 20. DNN 30 may employ a beam search algorithm to select specific characters based on their likelihood of utterance (e.g., having the highest probabilities 30P). As known in the art, beam search may be a search algorithm that explores a graph by expanding a limited number of promising nodes at each level. Beam search may maintain a set of top-k candidate sequences (where k is referred to as the beam width) at each step, and may prune lower-probability paths to reduce computational complexity while retaining likely candidates. DNN 30 may subsequently generate reference sequence 30R based on an aggregation of these selected alphabetical characters.

According to some embodiments DNN model 30 may learn the probability of characters 30P for each segment 20SEG (e.g., 20 millisecond frame) of the input signal 20, using a Connectionist Temporal Classification (CTC) loss function.

Pertaining to the example of audio transcription, during a training stage, system 100 may receive a training dataset that may include a sequence, or plurality of training input data segments 20SEG. Each training input data segment 20SEG may be annotated according to a corresponding transcription. In other words, the plurality of training input segments 20SEG may be annotated in a sense that they may be associated with respective annotations or labels, which indicate utterance of alphabetical characters (e.g., ‘a’, ‘b’, ‘c’, etc.) as phonemes in input 20.

System 100 may apply encoder 120 on the training input data segments 20SEG (or on their embedding representation 110EM), to generate a respective sequence of annotated, training encoding vectors 120EV. System 100 may then iteratively apply the feed-forward NN on one or more training encoding vectors 120EV, to obtain one or more respective, interim probability sets 30P.

As known in the art, Connectionist Temporal Classification (CTC) may refer to a technique for training sequence-to-sequence models where the alignment between input and output sequences is unknown. CTC may allow a model to learn without requiring pre-aligned training data, by summing over all possible alignments between the input and output sequences.

According to some embodiments, system 100 may employ a CTC 50 calculation module, to calculate a CTC loss value 50L based on the interim probability sets 30P. For example, CTC module 50 may use the interim probability sets 30P to compute probabilities for all possible alignments between the predicted character sequences and the annotated transcriptions. CTC module 50 may calculate CTC loss value 50L as a negative log-likelihood of the correct transcription given these probabilities.

System 10 may subsequently employ a training scheme (e.g., a backward propagation scheme) as known in the art, based on the CTC loss value 50L. In other words, system 10 may train the feed-forward NN of DNN model 30 according to the CTC loss value 50L, so as to predict the set of probabilities 30P (and hence—the reference sequence 30R), using the annotations of the training dataset's input segments 20SEG as supervisory information.

Pertaining to the example of image captioning, input signal 20 may include an image, which may be comprised of segments or tiles 20SEG. In such embodiments, the feed-forward NN of DNN 30 may be, or may include one or more object detection models. These models may be adapted to identify predetermined objects in the image, as known in the art. In this case, reference sequence 30R may describe a transformation of input data 20 (e.g., the image) as an indication of presence of these predetermined objects in image 20.

As elaborated herein, DNN 30 may process the encoding vectors 120EV in parallel with decoder 130 of transformer 10. Decoder 130 may generate a set of candidate sequences 10CS, each representing a first transformation of the input signal 20, e.g., as word, or sub-word tokens, while DNN 30 generate a second transformation of the input signal 20, e.g., as a sequence of characters.

As known in the art, a decoder (e.g., decoder 130) of a transformer-based transcription model may exhibit various benefits, such as attention mechanisms. However, such decoders are also inherently exposed to audio information which spans beyond that of single tokens (e.g., words), and are therefore susceptible to producing hallucinatory candidate sequences 10CS. In contrast, CTC based prediction of single-character likelihood is typically exposed to a very limited number (e.g., a single) of phoneme utterances, and is therefore not susceptible to producing hallucinatory reference sequence 30R. It may therefore be appreciated that the combination of these two disciplines may provide the benefit of attention-based transformers, while mitigating susceptibility to hallucination.

In other words, by applying the feed-forward NN of DNN 30 to the encoding vectors 120EV, DNN 30 may provide a reference point against which the candidate sequences 10CS generated by the decoder 130 can be compared. This comparison may help in identifying potential hallucinations or errors in the transformation process performed by transformer 10.

The outputs from both DNN 30 (reference sequence 30R) and decoder 130 (candidate sequences 10CS) may be provided to an alignment module 40 for further processing and evaluation. Alignment module 40 may be configured to compare and align candidate sequences 10CS generated by the decoder 130 with reference sequence(s) 30R obtained from DNN 30.

According to some embodiments, alignment module 40 may employ a dynamic programming algorithm to align at least one candidate sequence 10CS of the set of candidate sequences 10CS with reference sequence 30R.

According to some embodiments, alignment module 40 may employ a dynamic programming algorithm to align at least one candidate sequence 10CS of the set of candidate sequences 10CS with reference sequence 30R. As known in the art, dynamic programming may refer to a method for solving complex problems by breaking them down into simpler subproblems and storing the results of these subproblems to avoid redundant computations. Examples of dynamic programming algorithms that may be employed for sequence alignment may include edit distance algorithms, Needleman-Wunsch algorithms, or Smith-Waterman algorithms.

Alignment module 40 may then generate an alignment score 40S based on the comparison and alignment of each candidate sequence 10CS with the reference sequence 30R. Alignment score 40S may represent a degree of similarity or correspondence between a specific candidate sequence 10CS and the reference sequence 30R. For example, alignment score 40S may include a Mapping Quality (MAPQ) score, or a confidence score as known in the art, to indicate quality of alignment between candidate sequence 10CS and reference sequence 30R. The alignment score 40S may be calculated based on various factors, such as the number of matching characters or tokens between the candidate sequence 10CS and the reference sequence 30R, gap penalties that may be applied when insertions or deletions are required to align the sequences, or normalized similarity metrics that may account for differences in sequence lengths. In some embodiments, the alignment score 40S may be computed as a weighted combination of these factors.

For example, sequences 10CS with probability scores 40S below a predefined threshold may be flagged as hallucinations by the hallucination indicator 60H. The threshold may be predetermined based on empirical testing, application requirements, or desired sensitivity levels. In some embodiments, the threshold may be adjusted dynamically based on the characteristics of the input signal 20 or the specific use case. This approach may allow system 100 to identify candidate sequences 10CS that deviate significantly from the reference sequence, potentially indicating the presence of hallucinated content.

As known in the art, a decoder (e.g., decoder 130) of a transformer-based transcription model may produce its output sequence 10-OUT iteratively, where each iteration includes incorporation of previously calculated tokens into candidate sequences 10CS. According to some embodiments, the alignment method implemented by the alignment module 40 may allow for precise indication (indicator 60H) of the onset location of hallucinated segments 20SEG within the candidate sequences 10CS. By comparing the aligned sequences, system 100 may pinpoint where a candidate sequence 10CS begins to diverge from the reference sequence, potentially indicating the start of a hallucinated segment.

Upon detecting an onset of hallucination, system 100 may take one or more remedial actions. For example, system 100 may terminate generation of the candidate sequence 10CS to avoid further hallucinated content. In another example, system 100 may backtrack to a previous token in the candidate sequence 10CS and resume generation from that point using alternative token predictions. In yet another example, system 100 may re-score alternative candidate sequences 10CS to identify a non-hallucinated candidate for continued generation. It may be therefore appreciated that system 100 may thus facilitate early discarding of hallucinatory output in generative models, to improve the efficiency and throughput of transformer-based computing processes.

In some cases, system 100 may identify a specific candidate sequence 10CS as a hallucination based on its probability score. This identification may be performed by comparing the probability score of the candidate sequence 10CS to a predetermined threshold or by ranking the probability scores of multiple candidate sequences 10CS and selecting those with the lowest scores as potential hallucinations.

By implementing this alignment and hallucination detection process, the system 100 may enhance the reliability of the transformer 10 by grounding the decoder's predictions to the actual input signal 20, whether it be speech or image data. This approach may help mitigate the occurrence of hallucinations in the output of transformer-based models, potentially improving their performance in various applications such as speech recognition or image captioning.

A number of implementations have been described. Nevertheless, it will be understood that various modifications may be made without departing from the spirit and scope of the disclosure. Accordingly, other implementations are within the scope of the following claims.

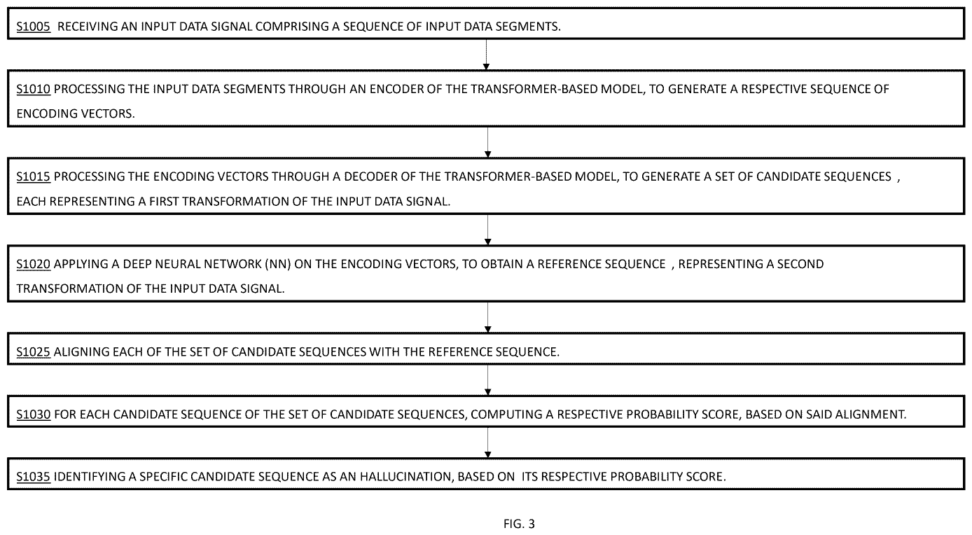

Reference is now made to FIG. 3, which is a flow diagram, depicting steps in a method of detecting hallucinations in transformer-based models by at least one processor (e.g., processor 2 of FIG. 1), according to some embodiments.

As shown in step S1005, the at least one processor 2 may receive an input data signal (e.g., 20 of FIG. 2), that may include a sequence of input data segments (e.g., 20 SEG of FIG. 2). For example, the input data signal may be, or may include an audio file or stream, which includes segments 20SEG of recorded speech. In another example, input data signal 20 may include an image, which may be comprised of one or more segments or tiles 20SEG.

As shown in step S1010, the at least one processor 2 may process the one or more input data segments 20SEG through an encoder (e.g., encoder 120 of FIG. 2) of a transformer-based model (e.g., transformer 10 of FIG. 2), to generate a respective sequence of encoding vectors (e.g., encoding vector(s) 120EV of FIG. 2). The at least one processor 2 may process the encoding vectors (120EV, step S1015) through a decoder (e.g., decoder 130 of FIG. 2) of the transformer-based model 10, to generate a set of candidate sequences (e.g., candidate token sequence(s) 10CS of FIG. 2).

Each candidate token sequence 10CS may represent a first transformation of the input data signal 20. In the example of audio transcription, candidate token sequence(s) 10CS may include a stream of words, which are postulated to have been uttered, and recorded in input signal 20.

As shown in step S1020, the at least one processor 2 may apply a deep Neural Network (NN) (e.g., DNN or feed-forward network 30 of FIG. 2) on the encoding vectors 120EV, to obtain a reference sequence (e.g., 30R of FIG. 2). Reference sequence 30R may represent another transformation of the input data signal.

Pertaining to the example of audio transcription, reference sequence 30R may include a sequence of alphabetical characters which may have been uttered, and recorded in input signal 20.

As shown in steps S1025, S1030, the at least one processor 2 may align each candidate 10CS of the set of candidate sequences 10CS with the reference sequence, and compute, for each candidate sequence 10CS, a respective probability score (e.g., 40S of FIG. 2), based on the alignment.

As shown in steps S1035, the at least one processor 2 may subsequently identify a specific candidate sequence 10CS as an hallucination, based on its respective probability score (e.g., when the score is below a predetermined threshold).

As explained herein, embodiments of the invention may be adapted to mitigate generation of hallucinated data, and/or indicate onset of hallucinations in computing systems that are adapted to implement transformer-based methods of Artificial Intelligence (AI). Embodiments of the invention may therefore provide a practical application for improving reliability, and performance of such computing systems.

It may be appreciated that the methods taught herein may not be practically implemented as a mental process due to the computational complexity involved. For example, processing thousands of encoding vectors through multiple neural network layers, computing probability distributions across extensive character vocabularies, and performing dynamic programming alignment on sequences of significant length may require computational resources that exceed human cognitive capabilities. The iterative generation of candidate sequences, combined with real-time alignment scoring and threshold-based hallucination detection, may involve operations that are inherently tied to computer-based processing.

Embodiments of the invention may be embedded as a practical application by improving computer technology, specifically by enhancing the reliability, accuracy, and computational efficiency of transformer-based computing systems. By detecting hallucinations early during the iterative generation process, embodiments may reduce wasted computational resources that would otherwise be expended on generating and processing hallucinated content.

Pertaining to examples of audio data analysis, embodiments of the invention may improve speech recognition systems by reducing erroneous transcriptions, improving speech-to-text accuracy, and enabling more reliable voice-controlled systems. For example, embodiments may mitigate repetitive hallucinations, word insertions, and fabrications in transcribed speech, thereby enhancing the utility of automated transcription services, voice assistants, and accessibility tools for hearing-impaired users.

Pertaining to examples of image data analysis, embodiments of the invention may improve image captioning systems by generating more accurate descriptions of image content, reducing false object identifications, and improving automated image description systems. For example, embodiments may prevent the generation of captions that describe objects or scenes not actually present in an image, thereby enhancing the reliability of image search engines, content moderation systems, and assistive technologies for visually-impaired users.

1. A method of mitigating hallucinations in a transformer-based model by at least one processor, the method comprising:
receiving an input data signal, comprising a sequence of input data segments; processing the input data segments through an encoder of the transformer-based model, to generate a respective sequence of encoding vectors;
processing the encoding vectors through a decoder of the transformer-based model, to generate a set of candidate sequences, each representing a first transformation of the input data signal;
applying a feed-forward Neural Network (NN) on the encoding vectors, to obtain a reference sequence, representing a second transformation of the input data signal;
aligning each of the set of candidate sequences with the reference sequence;
for each candidate sequence of the set of candidate sequences, computing a respective probability score, based on said alignment; and
identifying a specific candidate sequence as an hallucination, based on its respective probability score.

2. The method of claim 1, wherein generating the candidate sequences is performed by an iterative process, comprising:
obtaining a current set of candidate sequences, pertaining to a current iteration;
selecting a specific candidate sequence of the current set of candidate sequences as optimal, based on the probability scores; and
in a subsequent iteration, generating a new set of candidate sequences, based on the optimal candidate sequence.

3. The method of claim 1, wherein the input data signal is an audio signal, comprising recorded speech, and wherein the first transformation represents a transcription of the recorded speech into a sequence of tokens, selected from natural-language words and sub-word units, thereby forming the candidate sequence.

4. The method of claim 1, wherein the input data signal is an audio signal, comprising recorded speech, and wherein the second transformation represents a transcription of the recorded speech into a sequence of natural-language alphabetical characters, thereby forming the reference sequence.

5. The method of claim 4, further comprising:
employing the feed-forward NN to predict, for each input data segment, a set of probabilities, wherein said set of probabilities represents likelihood of utterance of phonemes, which correspond to respective alphabetical characters;
applying a beam search algorithm on the set of probabilities, to select specific characters based on their likelihood of utterance; and
generating the reference sequence based on the selected alphabetical characters.

6. The method of claim 5, further comprising:
receiving a sequence of training input data segments, each annotated according to a corresponding transcription;
applying the encoder on the training input data segments, to generate a respective sequence of training encoding vectors;
applying the feed-forward NN on one or more training encoding vectors, to obtain one or more respective, interim probability sets;
calculating a Connectionist Temporal Classification (CTC) loss value, based on the interim probability sets; and
training the feed-forward NN to predict said reference sequence based on the CTC loss value.

7. The method of claim 1, wherein said aligning comprises employing a dynamic programming algorithm, to align at least one candidate sequence of the set of candidate sequences with the reference sequence.

8. The method of claim 1, wherein the input data signal comprises an image, and wherein the first transformation represents an image captioning, comprising textual description of content of one or more elements depicted in the image.

9. The method of claim 8, wherein the feed-forward NN comprises one or more object detection models, adapted to identify predetermined objects in the image, and wherein the second transformation comprises indication of presence of said predetermined objects in the image.

10. A system for mitigating hallucinations in a transformer-based model, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive an input data signal, comprising a sequence of input data segments;
process the input data segments through an encoder of the transformer-based model, to generate a respective sequence of encoding vectors;
process the encoding vectors through a decoder of the transformer-based model, to generate a set of candidate sequences, each representing a first transformation of the input data signal;
apply a deep Neural Network (NN) on the encoding vectors, to obtain a reference sequence, representing a second transformation of the input data signal;
align each of the set of candidate sequences with the reference sequence;
for each candidate sequence of the set of candidate sequences, computing a respective probability score, based on said alignment; and
identify a specific candidate sequence as an hallucination, based on its respective probability score.

11. The system of claim 10, wherein the at least one processor is configured to generate the candidate sequences in an iterative process, comprising:
in a first iteration, obtaining a current set of candidate sequences, pertaining to a current iteration; and
selecting a specific candidate sequence of the current set of candidate sequences as optimal, based on the probability scores; and
in a subsequent iteration, generating a new set of candidate sequences, based on the optimal candidate sequence.

12. The system of claim 10, wherein the input data signal is an audio signal, comprising recorded speech, and wherein the first transformation represents a transcription of the recorded speech into a sequence of tokens, selected from natural-language words and sub-word units, thereby forming the candidate sequence.

13. The system according to claim 10, wherein the input data signal is an audio signal, comprising recorded speech, and wherein the second transformation represents a transcription of the recorded speech into a sequence of natural-language alphabetical characters, thereby forming the reference sequence.

14. The system of claim 13, wherein the at least one processor is further configured to:
employ the deep NN to predict, for each input data segment, a set of probabilities, wherein said set of probabilities represents likelihood of utterance of phonemes, which correspond to respective alphabetical characters;
apply a beam search algorithm on the set of probabilities, to select specific characters based on their likelihood of utterance; and
generate the reference sequence based on the selected alphabetical characters.

15. The system of claim 14, wherein the at least one processor is further configured to:
receive a sequence of training input data segments, each annotated according to a corresponding transcription;
apply the encoder on the training input data segments, to generate a respective sequence of training encoding vectors;
apply the deep NN on one or more training encoding vectors, to obtain one or more respective, interim probability sets;
calculate a Connectionist Temporal Classification (CTC) loss value, based on the interim probability sets; and
train the deep NN to predict said reference sequence based on the CTC loss value.

16. The system according to claim 10, wherein said aligning comprises employing a dynamic programming algorithm, to align at least one candidate sequence of the set of candidate sequences with the reference sequence.

17. The system of claim 10, wherein the input data signal comprises an image, and wherein the first transformation represents an image captioning, comprising textual description of content of one or more elements depicted in the image.

18. The system of claim 17, wherein the deep NN comprises one or more object detection models, and wherein the at least one processor is further configured to employ the one or more object detection models, to identify predetermined objects in the image so as to generate the second transformation as an indication of presence of said predetermined objects in the image.

19. A system for early detection of hallucinations in a transformer-based model, the system comprising: a non-transitory memory device, wherein modules of instruction code are stored and at least one processor associated with the memory device, and configured to execute the modules of instruction code, whereupon execution of said modules of instruction code, the at least one processor is configured to:
receive an input data signal, comprising a sequence of input data segments;
process the input data segments through an encoder of the transformer-based model, to generate a respective sequence of encoding vectors;
apply a deep Neural Network (NN) on the encoding vectors, to obtain a reference sequence representing a transformation of the input data signal;
iteratively generate, through a decoder of the transformer-based model, a set of candidate sequences based on the encoding vectors, wherein each iteration incorporates previously generated tokens into the candidate sequences;
during said iterative generation, align each candidate sequence with the reference sequence to determine an alignment score; and
identify an onset location of a hallucinated segment within a candidate sequence by pinpointing where the candidate sequence begins to diverge from the reference sequence based on the alignment score, prior to completion of the iterative generation.
